(19) United States
(12) Patent Application Publication
(10) Pub. No.: US 2013/0127897 A1
(43) Pub. Date: May 23, 2013

(54) DUAL GRAPHIC DISPLAY

(71) Applicant: Visteon Global Technologies, Inc., Van Buren Township, MI (US)

(72) Inventors: Mark James Arthur Baker, Grays (GB); Dan Gullick, Chelmsford (GB); Grace Bramer, Bath (GB); Steven Purcell, Basildon (GB)

(73) Assignee: VISTEON GLOBAL TECHNOLOGIES, INC., Van Buren Township, MI (US)

(21) Appl. No.: 13/667,586

(22) Filed: Nov. 2, 2012

(30) Foreign Application Priority Data
Nov. 18, 2011 (GB) 1119975.9

(51) Int. Cl. G09G 5/02; B23P 11/00; G09G 5/00

(52) U.S. Cl. 345/593; 345/629; 29/428; 29/458

(57) ABSTRACT

A dual graphic display unit and a method of assembling such a display unit are provided. The display unit relates to a motor vehicle and includes a display area with two display graphics. The dual graphics may be overlapping and are selectable such that the graphics may be suppressed or displayed to a user of the display unit separately or together. The display unit may include a polarizing filter assembly, a source of polarized illumination for backlighting the assembly to generate the images, and means for activating the source to selectively provide a first polarization to generate the first graphic image and a second polarization to generate the second graphic image.

### RELATED APPLICATIONS

The present application claims priority to co-pending United Kingdom Patent Application No. 1119975.9, filed Nov. 18, 2011, which is incorporated herein by reference in its entirety.

### FIELD OF THE INVENTION

The present invention related to a dual graphic display unit and to a method of assembling such a unit, and in particular relates to a display unit for a motor vehicle, having a display area with two display graphics. The dual graphics may be overlapping and are selectable such that the graphics may be suppressed or displayed to a user of the display unit separately or together.

### BACKGROUND

There has been a trend in recent years for motor vehicle displays to increase in the size and to become more complex functionally. There is, however, a limit to the size and complexity of practical automotive displays. Dashboard space is also increasingly at a premium in automobiles.

Rather than increasing the size, complexity and cost of displays, for example touch-screen color LCD displays, it may be preferable in many applications to provide a number of inexpensive control buttons or touch-sensitive control areas on a dashboard and which present to a user different display graphics depending on the activation of the control.

Therefore, there is a need for increased flexibility and functionality of control buttons or areas, which may, for example, be used in conjunction with an adjacent display screen. When the button or control area is activated, there is then a change in the displayed graphic to indicate the control selection by the user.

In one known approach, a light source providing different colored light is used together with different color filters associated with different graphics to switch the graphics displayed on a button. This, however, limits the colors available and prevents two graphics from having the same or similar color.

Each graphic has its own color filter that only lets through or passes a narrow band of wavelengths. These filters are chosen so that the wavelengths passed do not overlap. The graphics are placed on top of each other and where they overlap, each graphic, instead of being colored is translucent with a neutral density which dims the passed light by an appropriate amount to match the light intensity emitted by non-overlapping parts of the graphic.

Each graphic is then back-illuminated, using two light sources each with a different wavelength which correspond to one of the color filters, for example a red light illuminates the red graphic and a blue light illuminates the blue graphic. The red filter allows the red light to pass through but the blue filter does not allow the blue light through. As a result, when only the red light is illuminated only the red graphic is visible and when only the blue light is illuminated only the blue graphic is visible. To achieve a white graphic a phosphor layer is applied after the color filters. The phosphor layer is then excited by the blue light to produce a nearly white image.

Another known approach is to incorporate an active display screen in the button, for example a monochrome or color LCD screen, but this method is expensive.

Another known approach is to use a projection method used as a display indicator, however, this introduces additional mechanical complexity and cost, and may introduce long terms concerns regarding reliability.

It is an object of the present invention to provide a more convenient display unit for selectively displaying to a user, either individually or together, an image of a first graphic and an image of a second graphic. It is also an object of the present invention to provide a method of assembling such a display unit.

### SUMMARY

According to one aspect, there is provided a display unit for selectively displaying to a user, either individually or together, an image of a first graphic and an image of a second graphic, the display unit comprising a polarizing filter assembly, a source of polarized illumination for backlighting said assembly to generate said images, and means for activating said source to selectively provide a first polarization to generate the first graphic image and a second polarization to generate the second graphic image, the polarizing filter assembly comprising a first display element and a second display element, said display elements being joined to each other, the first display element having a first polarizing pattern and the second display element having a second polarizing pattern, said first and second patterns, when illuminated respectively with said first and second polarizations generating said first and second graphic images, wherein:

the first display element comprises a first substrate layer and on said substrate layer a first polarizing layer, the first polarizing layer providing the first polarizing pattern;

the second display element comprises a second substrate layer and on said substrate layer a second polarizing layer, the second polarizing layer providing the second polarizing pattern;

each of said substrate layers is substantially transparent or translucent to both polarizations of said polarized illumination; and

the first display element is joined to the second display element along an interface between the first polarizing layer and the second polarizing layer to form said polarizing filter assembly.

In the context of the present invention, the term “graphic” is not restricted to mean only pictorial devices, but includes any type of graphical item displayed on a display area for a user of the display unit, including alphanumeric symbols.

The back-illumination of the first and second polarizations may be provided at different times when it is desired to display the first and second graphic images at different times. The back-illumination may be switched off when neither of the graphics is to be displayed. However, if the display of the two graphics are compatible with each other, then both the first and second polarizations may be provided at the same time.

The first and second display elements are therefore bonded together such that the first and second polarizing patterns are sandwiched between the first and second substrate layers.

In one exemplary embodiment, the first graphic image and the second graphic image are overlapping, and are displayed individually, i.e. one at a time or alternately, to a user of the display.

The two polarizations are most preferably orthogonal to each other, for example being linear polarizations at right angles to each other or alternatively left circular and right circular polarizations. Each polarizing pattern then consists of areas with different polarizations which either absorb or which transmit light of the two polarizations. In an exemplary embodiment, these areas include substantially transparent or translucent areas which transmit both polarizations substantially equally.

In order to provide a display unit in which the first and second display graphics have different colors, the first polarization and the second polarization of the light source may have different colors. The first and second display graphics will then have correspondingly different colors.

The first and second substrate layers are, in one embodiment, substantially non-polarizing.

In one exemplary embodiment, the first display element is bonded to the second display element along the interface between the first polarizing layer and the second polarizing layer, for example by ultrasonic welding, thermal welding or by means of an adhesive.

The polarizing filter assembly comprises an adhesive layer extending along the interface between the first polarizing layer and the second polarizing layer to bond the first display element to the second display element. The adhesive layer is index-matched to the refractive index of the adjacent polarizing layers.

The adhesive layer may also be substantially transparent or translucent to polarized illumination, and for this reason the adhesive layer is also non-polarizing.

At least one of the two polarizing patterns may consist of at least one non-polarizing area and at least one polarizing area. The polarizing areas of each pattern will substantially pass one of the two polarizations and substantially block the other of the polarizations. The non-polarizing area will pass both polarizations.

In one exemplary embodiment, both the first and second polarizing patterns may consist of at least one non-polarizing area and at least one polarizing area, the non-polarizing areas of the first and second polarizing patterns overlapping with each other. Therefore, the overlapping non-polarized area will pass both polarizations.

Also, a method of assembling a display unit is provided for selectively displaying to a user, either individually or together, an image of a first graphic and an image of a second graphic, the display unit comprising a polarizing filter assembly, a source of polarized illumination for providing a first polarization and a second polarization, the polarizing filter assembly comprising a first display element and a second display element, the method comprising the steps of:
i) forming a first display element by printing a first polarizing pattern in a first polarizing layer on a substantially transparent or translucent first substrate layer to form the first display element, the first substrate layer supporting the first polarizing layer and the first polarizing pattern holding the first graphic;
ii) forming a second display element by printing a second polarizing pattern in a second polarizing layer on a substantially transparent or translucent second substrate layer to form the second display element, the second substrate layer supporting the second polarizing layer and the second polarizing pattern holding the second graphic;
iii) assembling the polarizing filter assembly by joining the first display element and the second display element along an interface between the first polarizing layer and the second polarizing layer; and
iv) positioning a source of polarized illumination on one side of the polarizing filter assembly to backlight said assembly so that, in use, said first polarization generates from the first polarizing pattern the first graphic image and said second polarization generates from the second polarizing pattern the second graphic image.

Step iii) may comprise the step of bonding the first display element to the second display element along the interface between the first polarizing layer and the second polarizing layer.

Step iii) may comprise the step of applying an adhesive layer along the interface between the first polarizing layer and the second polarizing layer, and curing of the adhesive layer to bond the first display element to the second display element.

### BRIEF DESCRIPTION OF THE DRAWINGS

The invention will now be further described, by way of example only, and with reference to the accompanying drawings, in which:

FIG. 1 is a schematic cross-section of a display unit according to an exemplary embodiment of the invention, for selectively displaying to a user, either individually or together, an image of a first graphic and an image of a second graphic;

FIG. 2 is a representation of the first graphic;

FIG. 3 is a representation of the second graphic; and

FIG. 4 shows the overlap between the first and second graphics.

### DETAILED DESCRIPTION

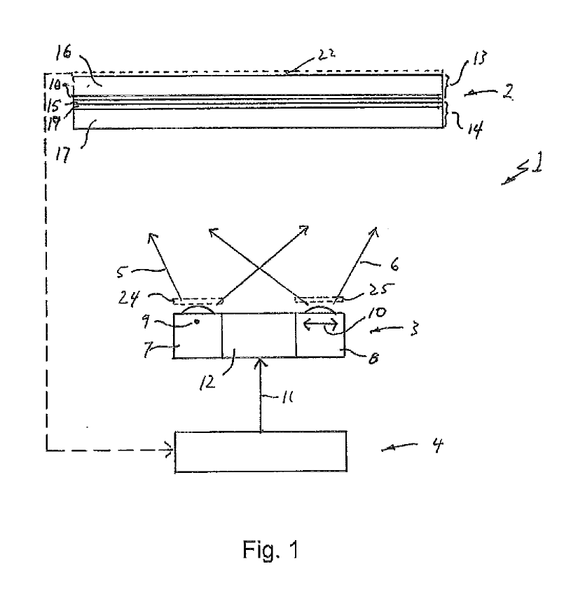

FIG. 1 shows a schematic cross-section of a display unit 1 for selectively displaying up to two graphics to a user. The graphics may be text, numerals symbols or any other type of visual indicia recognizable to a user of the device.

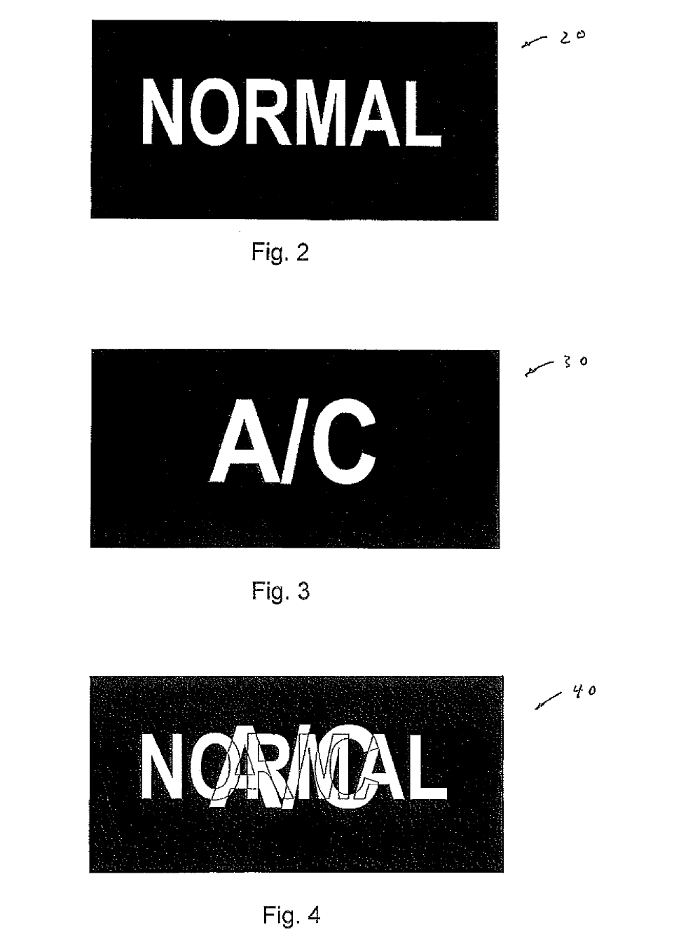

FIGS. 2 and 3 show, respectively, an example of an image 20 of a first graphic “NORMAL” and an image 30 of a second graphic “A/C”. The display unit 1 is arranged to display these separately, i.e. one at a time. The display unit may also suppress display of any graphic, so that the display unit presents a blank image to a user.

FIG. 3 shows how the display graphic images 20, 30 overlap spatially 40. In use, these would not be displayed together, but if the graphics were mutually compatible, then the display unit 1 could also display these together.

The display unit comprises a polarizing filter assembly 2, a source of polarized illumination 3 for backlighting the assembly 2 to generate the images 20, 30, and means 4 for activating the light source to selectively provide a first polarization 5 to generate the first graphic image 20 and a second polarization 6 to generate the second graphic image 30. In this example, the first and second polarizations 5, 6 are provided, respectively, by a first light element 7 and a second light element 8 with fixed orthogonal polarizations 9, 10, however, it would, alternatively, be possible to provide a single light source and an electro-optical device (not illustrated) to switch the polarizations. In this example, the first polarization is a linear polarization in and out of the plane of the drawing, represented by a dot 9, and the second polarization is a linear polarization in the plane of the drawing, represented by a double arrow 10. It would however, alternatively be possible to use right-hand and left hand circular polarizations.

The means 4 for activating the light source 3 provides a control signal 11 which is received by the a switch 12 in the source and which then activates the first or second light elements 7, 8 when one of the display graphics 20, 30 is to be displayed.

The polarizing filter assembly 2 is preferably a unitary assembly or structure. In this example, the assembly 2 comprises a first display element 13 and a second display element 14, these display elements being joined to each other along an interface 15, which in this example is provided by an index-matched adhesive.

The first and second display elements 13, 14 have, respectively a first substrate layer 16 and a second substrate layer 17. The substrate layers are a tough, clear plastic material, for example polycarbonate or polystyrene, about 1 mm thick. On the first and second substrate layers are printed, respectively, a first polarizing pattern in a first polarizing layer 18 and a second polarizing pattern in a second polarizing layer 19. These patterns are the same as the shape of the first and second display graphics 23, 30, and in this example are rectangular and about 20 mm wide and 45 mm long. As will be explained in more detail below, each polarizing pattern comprises polarizing and non-polarizing portions or areas. In this example, the first polarizing layer 18 is behind the second polarizing layer 19 with respect to the source 3, however, this arrangement may equally well be reversed.

When these polarizing layers are back illuminated by, respectively the first and second polarizations 5, 6, a user will be able to view one of the corresponding first and second graphics 20, 30.

The polarizing layers 18, 19 consist of clear areas surrounding by polarizing areas. In this example, the areas within the bounds of the letters and symbols forming “NORMAL” and “A/C” are clear, and the surrounding areas are polarizing. This arrangement may, however, equally well be reversed in which case the graphics, instead of being light areas on a dark background, will be dark on a light background.

When polarized light 5 from the first light element 7 is used to backlight the assembly 2, then this light first passes through the second substrate 17 essentially unimpeded, apart from small losses due to reflections at external and internal interfaces. The light then impinges on the clear and polarized portions of the 20 second polarizing layer 19, and is passed essentially unimpeded through the clear portions. The polarizing portions of the second polarizing layer 19 are aligned parallel with the first polarization 5 so that this light is also passed by the second polarizing layer 19. In practice, it has been found that additional losses due to the presence of the polarized areas in the layer, as compared with the clear portions or areas, are about 3%. This is sufficiently small so as not to require in automotive applications a corresponding compensation in the clear portions of the polarizing layer 19. However, the clear areas could be provided with a compensating neutral density if so desired in order to exactly balance all the light from the first polarization 5 passed through all areas of the second polarizing layer 19.

This passed light then passes through the interface adhesive layer 15 essentially unimpeded, apart from small losses due to reflections at internal interfaces which are minimized by matching the refractive indexes of the adhesive layer to the adjacent first and second polarizing layers 18, 19.

The first polarization 5 then passes into the first polarizing layer 18. When the light impinges on the clear and polarized portions of the first polarizing layer 18, some of this light passes unimpeded through the clear areas or portions forming the first graphic 20. The surrounding polarizing portions of the first polarizing layer 18 are aligned at right angles with the first polarization 5 so that this light is blocked by the first polarizing layer 18. In practice, it has been found that it is possible to block about 97% of the light. The image of the first graphic 20 is then visible to a user of the display unit 1.

When polarized light 6 from the second light element 8 is used to backlight the assembly 2, then this light first passes through the second substrate 17 essentially unimpeded, apart from small losses due to reflections at external and internal interfaces. The light then impinges on the clear and polarized portions of the second polarizing layer 19. The polarizing portions of the second polarizing layer 19 are aligned at right angles with the second polarization 6 so that this light is blocked by the second polarizing layer 19. In practice, it has been found that it is possible to block about 97% of the light. The light also impinges on the clear portions of the second polarizing layer 19, and is passed essentially unimpeded through these clear portions.

This passed light then passes through the interface adhesive layer 15 essentially unimpeded, apart from small losses due to reflections at internal interfaces which are minimized by matching the refractive indexes of the adhesive layer to the adjacent first and second polarizing layers 18, 19.

The second polarization 6 then passes into the first polarizing layer 18. When the light impinges on the clear and polarized portions of the first polarizing layer 18, some of this light passes unimpeded through the clear areas or portions forming the first graphic 20. The surrounding polarizing portions of the first polarizing layer 18 are aligned parallel with the second polarization 6 so that this light is also passed by the first polarizing layer 18. In practice, it has been found that additional losses due to the presence of the polarized areas in the layer, as compared with the clear portions or areas, are about 3%. This is sufficiently small so as not to require in automotive applications a corresponding compensation in the clear portions of the polarizing layer 18. However, the clear areas could be provided with a compensating neutral density if so desired in order to exactly balance all the light from the second polarization 6 passed through all areas of the first polarizing layer 18. The image of the second graphic 30 is then visible to a user of the display unit 1.

The display unit 1 described above may be manufactured as follows. The first display element 13 is formed by printing the first polarizing pattern in the first polarizing layer 18 on the substantially transparent or translucent first substrate layer 16. The first substrate layer 16 then supports the first polarizing layer and the first polarizing pattern holds the first graphic. Similarly, the second display element 14 is formed by printing the second polarizing pattern in the second polarizing layer 19 on the substantially transparent or translucent second substrate layer 17. The second substrate layer 17 then supports the first polarizing layer and the first polarizing pattern holds the first graphic.

The polarizing filter assembly 2 is then assembled by joining the first display element 13 and the second display element 14 along the interface 15 between the first polarizing layer 18 and the second polarizing layer 19, for example by applying an adhesive layer 15 which is then cured to bond the display element 13, 14 together.

The source of polarized illumination 3 is then positioned on one side of the polarizing filter assembly 2 to backlight the assembly so that, in use, the first polarization 5 generates from the first polarizing pattern the first graphic image 20 and said second polarization 6 generates from the second polarizing pattern the second graphic image 30.

Finally, on/off control, and optionally dimming control, of the image graphics is provided by control elements such as the switch 12 or control means 4 for activating the illumination source 3.

Although not illustrated, the display unit 1 may be incorporated in a push-button, or if not movable, for example being incorporated into a non-moving button, for example, the continuous surface of a motor vehicle dashboard, may include a touch-sensitive layer 22 linked to the control unit 4. This may be an electrical or capacitative element such as a clear indium tin oxide (ITO) layer, on an outermost side of the polarizing filter assembly 2.

It is preferred if the polarized illumination 5, 6 is colored with different colors, for example by color filters 24, 25. The displayed graphics will then each present one of the two colors. Instead of filters it would also be possible to use selectable multi-color light sources, for example LED units having red, green and blue LEDs which may be activated individually or in combination. Such light may have a preferential polarization when emitted and it is necessary to improve the polarization, then a single polarizer (not illustrated) may be provided at the optical output of each light source.

Similarly, there may be one or more diffusing filters (not illustrated) between the source 3 and assembly 2 to provide a more even illumination, either in place of or in addition to the color filters 24, 25.

Compared with many conventional approaches, the invention presents a number of advantages. The optical alignment of the system is not critical on the exact positioning of any one component. This makes it easier to incorporate the polarizing assembly 2 of the display unit in a push-button where there may be relative movement between the button and the light source 3, which remains fixed in place, for example mounted on a circuit board within a vehicle dashboard.

The thickness of the glue layer 15 is also not critical, which makes the unit easier to manufacture.

The color presented by the graphics is limited only by the two polarized light sources.

A method is therefore provided that creates changeable button graphics using polarization of light, rather than color of light. Each graphic has a different polarization for example the first graphic will have horizontal polarization and the second graphic a vertical polarization. In the example described above, the polarization of the graphics is a nominal 90 degrees to each other. So that this polarization is compatible with the polarization of sunglasses, which may be worn by a user, these polarizations are preferably oriented at 45 degrees to the vertical. Alternatively, right and left circular polarizations may be used both in the two polarized lights and in the two polarizing layers. By changing the polarization of the light source so that it is the same as the polarization of the graphic to be displayed it is then possible to display each graphic individually and to switch between them. Changing the polarization of the light is conveniently achieved by having two light sources each with a different polarization that are switched on individually. It may also be achieved by having a single light source for which it is possible to change the polarization using a liquid crystal layer.

A major benefit is that the graphics can be any color or can be the same color for example two white graphics. Because the invention described above uses the polarization of the provided light, rather than the color of provided light, to select the displayed graphic, it allows for the different displayed graphics to be either the same color or different colors, depending on the color of the polarized light used to back-illuminate the graphic display. The invention therefore also allows the use of broadband light sources, for example white light emitting 30 diodes (LEDs) composed of different wavelength LEDs.

A more convenient display unit is also provided for selectively displaying to a user, either individually or together, an image of a first graphic and an image of a second graphic, and also provides a convenient method of assembling such a display unit.

What is claimed is:

1. A display unit for selectively displaying to a user, either individually or together, an image of a first graphic and an image of a second graphic, the display unit comprising:
a polarizing filter assembly;
a source of polarized illumination for backlighting said assembly to generate said images; and
means for activating said source to selectively provide a first polarization to generate the first graphic image and a second polarization to generate the second graphic image;
wherein the polarizing filter assembly includes a first display element and a second display element, said display elements being joined to each other, the first display element including a first polarizing pattern and the second display element including a second polarizing pattern, said first and second patterns, when illuminated respectively with said first and second polarizations, generating said first and second graphic images; and wherein
the first display element includes a first substrate layer and on said substrate layer a first polarizing layer, the first polarizing layer providing the first polarizing pattern,
the second display element including a second substrate layer and on said substrate layer a second polarizing layer, the second polarizing layer providing the second polarizing pattern,
each of said substrate layers is substantially transparent or translucent to both polarizations of said polarized illumination, and
the first display element is joined to the second display element along an interface between the first polarizing layer and the second polarizing layer to form said polarizing filter assembly.

2. A display unit as claimed in claim 1, in which the first display element is bonded to the second display element along said interface.

3. A display unit as claimed in claim 2, in which the polarizing filter assembly further includes an adhesive layer extending along said interface to bond the first display element to the second display element.

4. A display unit as claimed in claim 3, in which the adhesive layer is substantially transparent or translucent to said polarized illumination.

5. A display unit as claimed in claim 3, in which the adhesive layer is index-matched to the refractive index of both of said polarizing layers.

6. A display unit as claimed in claim 5, in which the adhesive layer is substantially transparent or translucent to said polarized illumination.

7. A display unit as claimed in claim 1, in which the first polarization and the second polarization of the light source have different colors so that said first and second graphic images have correspondingly different colors.

8. A display unit as claimed in claim 1, in which at least one of said first and second polarizing patterns includes at least one non-polarizing area and at least one polarizing area.

9. A display unit as claimed in any of claims 1, in which both said first and second polarizing patterns include at least one non-polarizing area and at least one polarizing area, said non-polarizing areas of said first and second polarizing patterns overlapping with each other.

10. A display unit as claimed in claim 1, in which the display unit is part of a control button which, when activated, causes a change in said first and second graphic images.

11. A display unit as claimed in any of claims 1, in which the display unit is part of a touch-sensitive control area, when activated, causes a change in said first and second graphic images.

12. A method of assembling a display unit for selectively displaying to a user, either individually or together, an image of a first graphic and an image of a second graphic, the display unit including a polarizing filter assembly, a source of polarized illumination for providing a first polarization and a second polarization, the polarizing filter assembly including a first display element and a second display element, the method comprising the steps of:
i) forming a first display element by printing a first polarizing pattern in a first polarizing layer on a substantially transparent or translucent first substrate layer to form the first display element, the first substrate layer supporting the first polarizing layer and the first polarizing pattern holding the first graphic;
ii) forming a second display element by printing a second polarizing pattern in a second polarizing layer on a substantially transparent or translucent second substrate layer to form the second display element, the second substrate layer supporting the second polarizing layer and the second polarizing pattern holding the second graphic;
iii) assembling the polarizing filter assembly by joining the first display element and the second display element along an interface between the first polarizing layer and the second polarizing layer; and
iv) positioning a source of polarized illumination on one side of the polarizing filter assembly to backlight said assembly so that, in use, said first polarization generates from the first polarizing pattern the first graphic image and said second polarization generates from the second polarizing pattern the second graphic image.

13. A method as claimed in claim 12, in which step iii) comprises the step of bonding the first display element to the second display element along said interface.

14. A method as claimed in claim 13, in which step iii) comprises the step of applying an adhesive layer along said interface, and curing said adhesive layer to bond the first display element to the second display element.
